(19) United States
(12) Patent Application Publication
(10) Pub. No.: US 2018/0368431 A1
(43) Pub. Date: Dec. 27, 2018

(54) SYSTEM AND PROCESS FOR INCREASING SOLIDS CONTENT OF SKIM MILK OR WHEY

(71) Applicant: Tetra Laval Holdings & Finance S.A., Pully (CH)

(72) Inventors: Jacob Jacobsen, Silkeborg (DK); Karsten Lauritzen, Galten (DK)

(21) Appl. No.: 16/064,222

(22) PCT Filed: Nov. 15, 2016
(86) PCT No.: PCT/EP2016/077672

§ 371 Date: Jun. 20, 2018

(30) Foreign Application Priority Data
Dec. 21, 2015 (SE) 1551690-9

(51) Int. Cl. A23C 9/142; A23C 21/00

(52) U.S. Cl. CPC A23C 9/1427; A23C 2210/20; A23C 21/00; A23C 9/1425

(57) ABSTRACT

The present disclosure relates to systems and processes for production of a concentrate of skim milk or whey. Such systems and processes may include the steps of providing a feed of skim milk or whey, subjecting said feed to a reverse osmosis to obtain a reverse osmosis permeate and a concentrate of skim milk or whey, and subjecting the concentrate of skim milk or whey to an ultra-filtration to obtain an ultra-filtration permeate and a retentate of skim milk or whey.

### TECHNICAL FILED

The present invention relates to a process and system for concentration of skim milk or whey.

### BACKGROUND

Within the dairy business there is a demand to occasionally increase the solids content of the processed products, which may be skim milk or whey. The demand may be based on desired characteristics of a product or lowering of handling costs outside the production site.

To increase the solids content, reverse osmosis is today a commonly used method. A solids content of about 9-35 wt % is obtainable in a skim milk process, and for a whey process a solid content of about 6-30 wt % is obtainable. However, if a higher solids content is desirable other techniques are to be considered. Reverse osmosis has limitations to how high the obtainable solids content may be. The membranes used for reverse osmosis have a very small pore size and the membrane is designed to allow only water to pass through. This process requires that a high pressure is exerted on the high concentration side of the membrane. The process is limited by the osmotic pressure of the retentate and limitations of the pressure in the membrane filtration system.

Evaporators may be used to remove water from a milk processing system. Evaporators are able to obtain a solids content of up to about 40-50 wt %. However, evaporators are large, bulky, space occupying apparatuses which demand large investment costs, not only in the equipment itself but also additional expansion of buildings is often demanded. The size of evaporators for use in the dairy business makes it difficult to in a simple manner incorporate them into an existing processing unit and building.

There is a demand to find new ways to increase the solids content of skim milk or whey in a cost efficient manner, without huge investments in building structures.

### SUMMARY

The present invention provides a process for increasing the solids content of skim milk or whey, possibly decreased energy consumption, and without the need for expensive enlargement of the building structure around the process. The present invention also allows for lowered transport costs.

One aspect of the present invention is to provide a process for production of a concentrate of skim milk or whey, comprising the steps of

providing a feed of skim milk or whey,

subjecting said feed to a reverse osmosis to obtain a reverse osmosis permeate and a concentrate of skim milk or whey, and

subjecting the concentrate of skim milk or whey to an ultra-filtration to obtain an ultra-filtration permeate and a retentate of skim milk or whey.

According to one embodiment the ultra-filtration permeate is returned to the feed of skim milk or whey before the reverse osmosis and/or as a feed before the reverse osmosis.

According to one embodiment the ultra-filtration is performed at a pressure of 1-45 bar, preferably 4-20 bar.

According to one embodiment the ultra-filtration includes filtration elements having cuttoff values between 1 000 and 50 000 kD, preferably between 1 000 and 10 000 kD, 1 000 and 5 000 kD.

According to one embodiment the retentate of skim milk or whey have a solids content of at least 36 wt %, preferably 36-50 wt %, preferably 38-50 wt %, preferably 40-50 wt %.

According to one embodiment no additional ultra-filtration is performed before the reverse osmosis.

One aspect of the present invention is to provide a system for production of a concentrate of skim milk or whey, comprising:

a feed for skim milk or whey,

a reverse osmosis device adapted to provide a reverse osmosis permeate and a concentrate of skim milk or whey, and

an ultra-filtration device adapted to provide an ultra-filtration permeate and a retentate of skim milk or whey,

wherein the ultra-filtration device is subsequent the reverse osmosis device.

According to one embodiment the system further comprises a recirculation device adapted for obtained ultra-filtration permeate to be 1) returned to the feed of skim milk or whey before the reverse osmosis device, and/or 2) an additional feed to the reverse osmosis device.

According to one embodiment the ultra-filtration device includes filtration elements having cuttoff values between 1 000 and 50 000 kD, preferably between 1 000 and 10 000 kD, 1 000 and 5 000 kD.

According to one embodiment no additional ultra-filtration device is incorporated before the reverse osmosis device.

### SHORT DESCRIPTION OF THE DRAWINGS

FIG. 1 shows a schematic scheme of the present system and process with an optional recirculation of the UF permeate.

### DETAILED DESCRIPTION

The present process relates to increasing the solids content of skim milk or whey. For the processing of milk, whole milk may be subjected to a separation providing cream and skim milk. In cheese making, the whey obtained during the process may be separated into whey cream and whey.

The obtained skim milk or whey may be concentrated by using it as a feed for a reverse osmosis (RO). The RO provides a RO permeate, which may mainly comprise water and may have a solids content of about 0% TS. The RO also provides a concentrate of skim milk or whey. The solids content at this stage may be about 6-35 wt % TS. The obtained concentrate of skim milk or whey is thereafter subjected to an ultra-filtration (UF). The UF provides a UF permeate and a retentate of skim milk or whey. The solids content at this stage of the retentate may be at least 36 wt % TS; e.g. 36-50 wt %, 38-50 wt %, or 40-50 wt %.

In one embodiment the ultra-filtration permeate is returned to the feed of skim milk or whey before the reverse osmosis. Alternatively, the ultra-filtration permeate is returned as a feed of its own for the reverse osmosis treatment. A combination of the two is also possible.

The ultra-filtration may be performed at a pressure of about 1-45 bar, e.g. about 4-20 bar.

The ultra-filtration may include filtration elements having cuttoff values of 1 000-50 000 kD, such as 1 000-10 000 kD or 1 000-5 000 kD.

According to the present invention it may be that no additional ultra-filtration is performed before the reverse osmosis. It is to be noted that known processes of treating whey may include a pretreatment of the whey with ultra-filtration (UF) before the UF permeate is treated using reverse osmosis. However, it is to be noted that the same product is not obtained as with the present process. Ultra-filtration membranes will remove high molecular-weight substances, colloidal materials, and organic and inorganic polymeric molecules which not are present in the UF permeate before the reverse osmosis. Thus, the obtained retentate according to the present invention differs substantially from that of known processes.

The present invention also relates to a system for production of a concentrate of skim milk or whey, comprising a feed for the skim milk or whey, a reverse osmosis device adapted to provide a reverse osmosis permeate and a concentrate of skim milk or whey, and an ultra-filtration device adapted to provide an ultra-filtration permeate and a retentate of skim milk or whey. The ultra-filtration device is to be connected subsequent of the reverse osmosis device.

The system may further comprise a recirculation device. The recirculation device is to be adapted for the obtained ultra-filtration permeate to be returned to the feed of skim milk or whey before the reverse osmosis device, and/or an additional feed to the reverse osmosis device. If the ultra-filtration permeate is returned as an additional feed, it may be without any connection to the feed of skim milk or whey, or a combination of the two.

The ultra-filtration device may includes filtration elements having cuttoff values of 1 000-50 000 kD, such as 1 000-10 000 kD or 1 000-5 000 kD.

According to one embodiment no additional ultra-filtration device(s) are incorporated into the system before the reverse osmosis device.

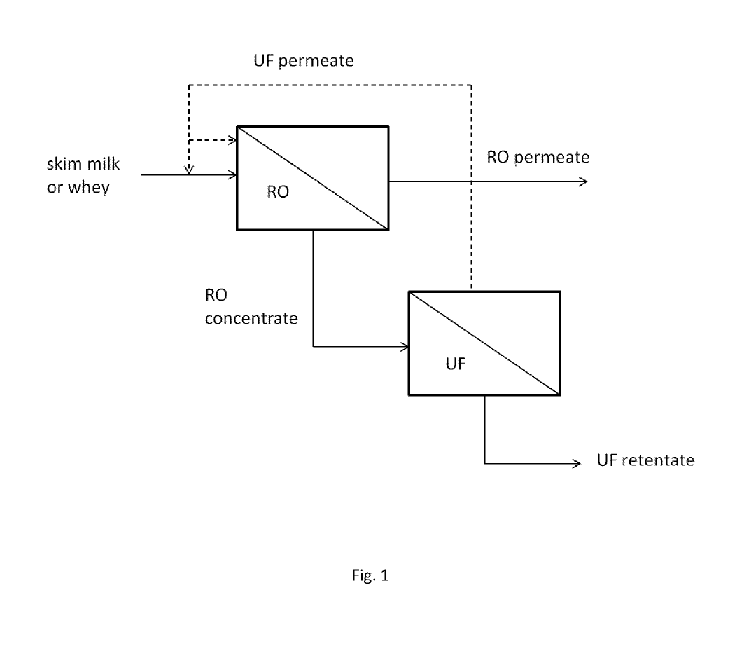

FIG. 1 shows the connection between the initial RO and subsequent UF. The outputs disclosed are RO permeate and UF retentate. Disclosed, as a dotted line is the recirculation of UF permeate, which may be introduced to the ingoing feed of the RO and/or as a separate feed to the RO.

As ultra-filtration uses membranes with bigger pore sizes compared to reverse osmosis membranes, a higher flux during the filtration is possible. There is a connection between the flux and the total solids content. As the solids content increases the flux is lowered due to more blockages in the membrane. Thus, also the pressure at the membranes increases. The pressure at a RO membrane is considerably higher than at a UF membrane as the pore sizes are smaller of the RO membrane. Sooner or later for UF or RO membranes the flux approaches 0 upon increased solids content. At this point the total solids content has reached its maximum. Increasing the pressure during the processes may influence to increase the solids content yet a little bit. However, this puts strain on the equipment. High pressure processes requires more expensive materials/apparatuses than low pressure processes. Also, some active milk or whey processes may be limited to certain pressures or the space available so that extra or larger equipment may not be feasible to introduce. By providing the combination of RO followed by UF there is surprisingly provided a way to concentrate skim milk or whey in a manner that is not as sensitive in view of flux for changes of the solids content. Thus, a considerably more concentrated product may be obtained without a substantial increase in pressure and/or decrease in flux.

1. A process for production of a concentrate of skim milk or whey, comprising the steps of:
providing a feed of skim milk or whey;
subjecting said feed to a reverse osmosis to obtain a reverse osmosis permeate and a concentrate of skim milk or whey; and
subjecting the concentrate of skim milk or whey to an ultra-filtration to obtain an ultra-filtration permeate and a retentate of skim milk or whey.

2. The process according to claim 1, wherein the ultra-filtration permeate is returned to the feed of skim milk or whey before the reverse osmosis and/or as a feed before the reverse osmosis.

3. The process according to claim 1, wherein the ultra-filtration is performed at a pressure of 1-45 bar.

4. The process according to claim 1, wherein the ultra-filtration includes filtration elements having cuttoff values between 1 000 and 50 000 kD.

5. The process according to claim 1, wherein the retentate of skim milk or whey have a solids content of at least 36 wt %.

6. The system according to claim 1, wherein no additional ultra-filtration is performed before the reverse osmosis.

7. A system for production of a concentrate of skim milk or whey, comprising:
a feed for skim milk or whey;
a reverse osmosis device adapted to provide a reverse osmosis permeate and a concentrate of skim milk or whey; and
an ultra-filtration device adapted to provide an ultra-filtration permeate and a retentate of skim milk or whey,
wherein the ultra-filtration device is subsequent the reverse osmosis device.

8. The system according to claim 7, further comprising a recirculation device adapted for obtained ultra-filtration permeate to be 1) returned to the feed of skim milk or whey before the reverse osmosis device, and/or 2) an additional feed to the reverse osmosis device.

9. The system according to claim 7, wherein the ultra-filtration device includes filtration elements having cuttoff values between 1 000 and 50 000 kD.

10. The system according to claim 7, wherein no additional ultra-filtration device is incorporated before the reverse osmosis device.

11. The process according to claim 3, wherein the ultra-filtration is performed at a pressure of 4-20 bar.

12. The process according to claim 4, wherein the cutoff values are between 1000 and 10000 kD.

13. The process according to claim 12, wherein the cutoff values are between 1000 and 5000 kD.

14. The process according to claim 5, wherein the solids content is between 36-50 wt %.

15. The process according to claim 14, wherein the solids content is between 38-50 wt %.

16. The process according to claim 15, wherein the solids content is between 40-50 wt %.

17. The system according to claim 9, wherein the cutoff values are between 1000 and 10000 kD.

18. The system according to claim 17, wherein the cutoff values are between 1000 and 5000 kD.
